(19) United States
(12) Patent Application Publication
(10) Pub. No.: US 2016/0122233 A1
(43) Pub. Date: May 5, 2016

(54) COATED GLASS SLEEVES AND METHODS OF COATING GLASS SLEEVES

(71) Applicant: CORNING INCORPORATED, CORNING, NY (US)

(72) Inventors: Thierry Luc Alain Dannoux, Avon (FR); Clemens Rudolf Horn, Guibeville (FR); Ronan Tanguy, Grez Sur Loing (FR)

(21) Appl. No.: 14/927,516

(22) Filed: Oct. 30, 2015

Related U.S. Application Data
(60) Provisional application No. 62/075,486, filed on Nov. 5, 2014.

(51) Int. Cl. C03C 17/10; C23C 18/16; C23C 18/18; C03C 17/00; C23C 18/44

(52) U.S. Cl. CPC C03C 17/10; C03C 17/004; C23C 18/44; C23C 18/1851; C23C 18/1605; C23C 18/1639; C23C 18/1689

(57) ABSTRACT

Disclosed are methods for coating or decorating a surface of a glass sleeve. The methods include depositing a metal layer onto a surface of the glass sleeve by an electroless plating method. Also disclosed are glass sleeves which are coated or decorated on an internal surface, and electronic devices comprising the coated glass sleeves.

This application claims the benefit of priority under 35 U.S.C. §119 of U.S. Provisional Application Ser. No. 62/075,486 filed on Nov. 5, 2014 the content of which is relied upon and incorporated herein by reference in its entirety.

### FIELD OF THE DISCLOSURE

The disclosure relates to surface coatings for glass sleeves, glass sleeves which are coated or decorated on at least one surface, and processes for coating or decorating at least one surface of a glass sleeve using an electroless plating method.

### BACKGROUND

Flat glass enclosures referred to as “sleeves” may be used in a wide variety of applications, including various electronics such as, for example, cell phones, electronic tablets, and other hand-held electronic devices. The glass sleeve can help protect components of the devices. Glass sleeves may be prepared by a variety of methods, for example by reforming a glass sleeve into the form of a sleeve, for example a monolithic sleeve made of parallel, opposite, flat and smooth front and back covers. Typically, after the sleeve is formed, the glass is treated, e.g. chemically strengthened, and then coated or decorated.

One design challenge that has been encountered with the formed glass sleeves relates to coating or decorating an internal surface thereof. While the external surface of the sleeve is easily accessed and processed, it may be preferable to coat or decorate the internal surface to avoid damage to the coating or decoration caused by handling of the device. However, due to the dimensions of the sleeve, the internal surface may be difficult to access and process in order to achieve the desired coating or decoration. Thus, traditional methods of coating or decorating glass, such as chemical vapor deposition, spray deposition, screen printing, or topography, may be difficult or may not work for the internal surface of a glass sleeve.

It would thus be advantageous to provide a method by which a glass sleeve, for example the internal surface of a glass sleeve, can be coated or decorated.

### SUMMARY

The disclosure relates, in various embodiments, to methods for coating a surface, e.g. an internal surface, of a hollow glass sleeve comprising contacting at least a portion of the surface of the glass sleeve with an electroless plating solution for a time sufficient to deposit a metal layer on at least a portion of the glass sleeve, where the electroless plating solution comprises at least one material for providing metal ions to the glass sleeve and at least one reducing agent.

A disclosed exemplary method comprises affixing a barrier to at least a portion of the internal surface of the hollow glass sleeve, contacting at least a portion of the internal surface of the glass sleeve with an electroless plating solution for a time sufficient to deposit a metal layer onto at least a portion of the internal surface of the glass sleeve, providing a protective layer to the portion of the glass sleeve comprising the deposited metal layer, and removing the barrier, wherein the electroless plating solution comprises at least one material for providing metal ions to the glass sleeve and at least one reducing agent.

The disclosure further relates to hollow glass sleeves comprising an internal surface, said internal surface comprising a layer of metal, wherein said layer of metal comprises trace amounts of at least one reducing agent.

The disclosure further relates to electronic devices having a glass enclosure comprising an internal surface, said internal surface comprising a layer of metal, wherein said layer of metal comprises trace amounts of at least one reducing agent.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings.

FIG. 1 illustrates a perspective view of an exemplary glass sleeve that may be coated according to various embodiments of the disclosure;

FIG. 2 illustrates a side cross-sectional view of an exemplary glass sleeve that may be coated according to various embodiments of the disclosure; and

FIGS. 3A and 3B are perspective views of electronic devices comprising exemplary glass enclosures coated according to various embodiments of the disclosure.

### DETAILED DESCRIPTION

According to various embodiments, surface coatings for glass sleeves and methods for coating or decorating at least one surface of a glass sleeve are disclosed. The methods include depositing a metal layer onto a surface, e.g. an internal surface, of the glass sleeve by an electroless deposition or plating method. In further embodiments, glass sleeves which are coated or decorated on a surface, e.g. an internal surface, are disclosed.

As used herein, the phrases “coating a glass sleeve,” “decorating a glass sleeve,” and variations thereof are intended to include depositing a layer of metal onto at least a portion of a glass sleeve. Thus, according to various methods described herein, a layer of metal may be deposited onto a portion of a glass sleeve but not onto other portions of the glass sleeve, yet such methods are intended to be included within the scope of the disclosure. By the term “coating” it is typically meant coating a relatively large portion of a surface, while by “decorating” it is meant coating a relatively smaller portion of a surface in order to add an aesthetic effect, e.g. adding a design or a logo, but it should be noted that the terms may be used interchangeably herein without intending to limit their scope.

As used herein, the phrase “glass sleeve” is used to describe any hollow glass cylinder of any cross-sectional shape, including but not limited to those with a circular cross-section, an elliptical cross-section, an oblong cross section, a rectangular cross-section, a square cross-section, and the like. The glass sleeve may comprise multiple glass members affixed together to form a hollow glass cylinder, or may comprise a monolithic glass cylinder, such as the glass sleeves or glass enclosures for electronic devices made according to the process described in WO 2014/036236 A1, incorporated by reference herein. The terms “sleeve” and “enclosure” may be used interchangeably herein, without intending to limit their scope.

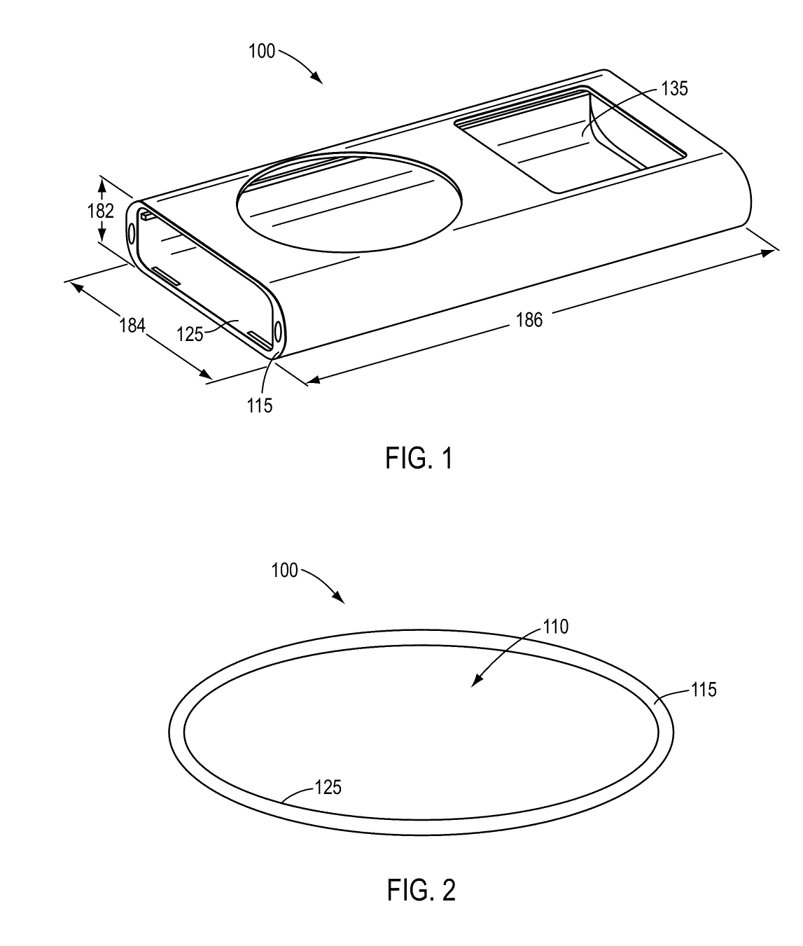

According to various embodiments, the glass sleeve may have any dimensions useful for the intended application. By way of example, as shown in FIG. 1 which is a non-limiting example of a hollow glass sleeve 100 with an oblong cross-section, the absolute height 182 of the glass sleeve may, for example, range up to about 15 mm, such as up to about 12 mm, up to about 10 mm, up to about 8 mm, up to about 6 mm, up to about 5 mm, or up to about 4 mm. In further embodiments, the absolute width 184 of the glass sleeve may, for example, range up to about 200 mm, such as up to about 150 mm, up to about 100 mm, 80 mm, up to about 70 mm, up to about 50 mm, up to about 40 mm, up to about 30 mm, or up to about 20 mm. In further embodiments, the absolute length 186 of the glass sleeve may, for example, range up to about 200 mm, such as up to about 150 mm, up to about 100 mm, up to about 70 mm, up to about 50 mm, up to about 40 mm, up to about 30 mm, or up to about 20 mm. As used herein, the absolute height 182, absolute width 184, and absolute length 186 are intended to include the measurement of the glass wall thickness 115, which may be, for example, up to about 2 mm, such as about 1 mm or up to about 0.5 mm, or alternatively which may vary around the circumference of the sleeve, for example having a variable thickness ranging up to about 2 mm.

The two-dimensional outer shape of the glass sleeve having dimensions 184×186 can be any shape, such as a square, rectangle, circle, ellipse, oval, oblong, and the like.

As seen in FIG. 2 which shows a side cross-sectional view of a hollow glass sleeve that may be coated or decorated according to various embodiments described herein, the hollow glass sleeve 100 may comprise a cavity 110 that defines the internal surface 125 of the hollow glass sleeve 100. The dimensions of the cavity 110 may be substantially the same as that of the absolute height 182×absolute width 184×absolute length 186, less the thickness of the glass wall 115. The cavity 110 may, according to various embodiments, optionally have length and/or width dimensions that are less than that of the glass sleeve 100, such as in an optional embodiment where the cavity does not cover the entire length or width of the glass sleeve 100.

According to various embodiments, after the glass sleeve is formed into the desired shape and/or dimensions, the glass may be treated by any method known. For example, the glass may be polished and/or strengthened, such as by chemical strengthening methods, for example by ion exchange.

### Methods

Once the glass sleeve is formed into the desired shape and treated, e.g. strengthened, it may be decorated or coated. As noted above, a design challenge with regard to decorating or coating glass sleeves for use in electronic and other devices relates to coating or decorating an internal surface of the sleeve after it is formed and treated. For example, an exemplary monolithic glass sleeve 100 having a cavity 110 that has a dimension of approximately 6 mm (height 182)×60 mm (width 184)×120 mm (length 186) would present challenges with regard to accessing the internal surface 125, in order to coat or decorate the internal surface by conventional means.

As described herein, methods for coating or decorating at least one surface, e.g. an internal surface, of a glass sleeve according to various embodiments may comprise a step of contacting at least a portion of the surface of the glass sleeve with an electroless plating solution. This may be referred to as “plating” the surface of the glass.

Electroless deposition methods use a chemical reducing agent that supplies electrons for metal deposition on a surface. The electroless plating solution may therefore comprise at least one material suitable to provide metal ions to the surface of the glass sleeve, as well as a least one reducing agent. In various embodiments, the electroless plating solution will have a pH that is basic. One of skill in the art will be able to determine an acceptable pH for the solution, for example depending on the metal ions to be deposited onto the glass surface.

According to various embodiments, the at least one material suitable to provide metal ions may comprise any metal suitable for an electroless plating technique. For example, the at least one metal may be chosen from palladium, gold, silver, tin, nickel, platinum, aluminum, and copper. One of skill in the art will appreciate that a different color may be attained through use of different metals.

By way of non-limiting example, the material suitable for providing metal ions to the surface of the glass sleeve may be chosen from metal-ion solutions such as water-soluble salts of palladium, gold, silver, tin, nickel, platinum, aluminum, and copper, for example in an aqueous solution. For example, aqueous solutions of silver nitrate or PdCl₂(NH3)₂ may be chosen. In at least certain exemplary embodiments, the at least one material suitable to provide metal ions may also be chosen from an aqueous solution of PdCl₂ to which NH3 is added.

According to various embodiments, the at least one reducing agent may be chosen from any reducing agent appropriate for reducing the material suitable for providing metal ions. One of skill in the art will be able to choose the appropriate reducing agent for the plating solution, depending on the metal ions to be deposited onto the glass surface. By way of non-limiting example only, glucose may be chosen as a reducing agent for electroless silver deposition, formaldehyde may be chosen for electroless copper deposition, and sodium hypophosphite may be chosen for electroless nickel deposition. Other useful reducing agents may include glycerol, hydrazine, sodium borohydride, amine boranes, triethanol amine, sodium sulfide, and titanium chloride, for example. However, any reducing agent useful in electroless plating methods can be chosen.

The electroless plating solution may be prepared by any method known. For example, a solution of the metal-ion containing material and a solution of the reducing agent may be prepared separately and then mixed just before the plating process begins. The electroless plating solution may further comprise any additive that is known to be useful in the plating solution or process, such as, for example stabilizers.

In addition to the above, other metals, reducing agents, additives, and other components useful in electroless plating solutions may be chosen. See, for example, Schlesinger, M. and Paunovic, M. (eds) (2010) Frontmatter, Modern Electroplating, Fifth Edition, John Wiley & Sons, Inc., Hoboken, N.J., which is incorporated by reference herein.

According to various embodiments, the plating step, i.e. contacting the plating solution to the glass, may be done by any method known, such as spray deposition. Further methods comprise, for example, immersing the glass sleeve in the solution, pouring the solution into the glass sleeve, or any other method which brings the solution into contact with the surface of the glass sleeve to be coated. Such methods may be particularly useful for plating an internal surface of the glass sleeve. By way of example, one end of a hollow glass sleeve intended for use in an electronic device may be sealed, and the electroless plating solution may be poured or otherwise disposed into the other end of the sleeve.

The surface of the glass sleeve intended to be coated or decorated, e.g. an internal surface, may be in contact with the electroless plating solution for a period of time sufficient for the solution to deposit a layer of metal onto the glass. The amount of time can vary, for example depending on the metal being deposited, the amount of pre-treatment, the area of the glass being plated, and/or the desired thickness of the layer of metal.

According to various embodiments, the layer of metal deposited onto the glass may comprise a thickness ranging up to about 5 μm, such as up to about 4 μm, up to about 3 μm, up to about 2.5 μm, up to about 2 μm, up to about 1.5 μm, or up to about 1 μm. For example, the layer of metal deposited may comprise a thickness ranging from about 0.1 μm to about 2 μm, such as from about 0.2 μm to about 2 μm, about 0.2 μm to about 1.5 μm, about 0.3 μm to about 1.5 μm, or about 0.3 μm to about 1 μm.

For example, the solution may be in contact with the glass for a period of time ranging up to about 10 minutes, such as up to about 8 minutes, up to about 5 minutes, up to about 3 minutes, up to about 2 minutes, or up to about 1 minute.

Optionally, the plating step may be performed under elevated temperature, or, for example, an additional step of exposing the glass sleeve to an environment having an elevated temperature subsequent to contacting the solution to the glass surface may be performed. It may, in at least certain embodiments, be advantageous for the solution to be exposed to elevated temperatures while it is in contact with the glass, as the elevated temperature may affect the speed of the metal deposition. The speed of the plating may, for example, impact the thickness and/or the quality of the layer of metal, and thus it may be desirable to control the speed of plating in at least certain embodiments.

By way of example, during the plating process, the glass sleeve in contact with the electroless plating solution may be subjected to a temperature ranging from about 25° C. to about 100° C., such as about 30° C. to about 90° C., about 50° C. to about 75° C., or about 60° C. The elevated temperature may be accomplished by any known method, such as, for example, placing the glass sleeve under a heat lamp, in an oven, or in a warm bath.

According to various embodiments, it may be desired that the temperature to which the glass sleeve is exposed during the plating process does not adversely affect the glass or plating solution. For example, it may be desirable that the temperature is below a temperature at which any ion-exchange hardening treatment of the glass, if present, would be affected.

According to various embodiments, the surface of the glass sleeve may optionally be pre-treated before the plating step, for example to eliminate mechanically distorted surface layers or to activate the surface to be coated. By way of example, this pre-treatment step may comprise cleaning the glass, etching the glass, and/or activating the glass. Optionally, according to various embodiments, the entire surface of the glass sleeve to be plated with the solution may be pre-treated, or in alternate embodiments, only a portion of the surface of the glass sleeve to be plated may be pre-treated.

By way of example only, the glass surface may be cleaned with alcohol and/or acetone, or etched, e.g. with hydrochloric acid or hydrofluoric acid. As a further example, the surface of the glass may be treated with an activating agent such as a tin(II) solution (e.g. an aqueous SnCl₂ solution, optionally comprising HCl) and/or a palladium solution (e.g. a PdCl₂ solution, optionally comprising HCl), and optionally rinsed with water.

According to various exemplary and non-limiting embodiments, it may be desirable for at least a portion of the surface of the glass sleeve to remain uncoated. By way of example only, in an embodiment of a glass sleeve intended for use in an electronic device, the device may have a display area that is intended to be viewed through the glass. Thus, it would be advantageous to prohibit the metal layer from being coated onto the area of the glass sleeve where the display would be located, in order for the glass to remain transparent.

As such, it is contemplated that in at least certain embodiments, the methods described herein further comprise a step, e.g. a pre-treatment step, of protecting at least a portion of the surface of the glass sleeve from exposure to or contact with the electroless plating solution. According to various embodiments, a barrier, e.g. a mask or other protective layer, may be affixed or applied to, or positioned on, at least a portion of the surface of the glass, in order to prevent deposition of the metal layer onto the protected portion of the surface. According to various embodiments, the barrier can be a temporary barrier, such that it can be removed after the metal layer is deposited onto the surrounding glass. It may be desirable in at least certain embodiments that the removal of the barrier not adversely affect, or not substantially adversely affect, the metal layer deposited on the glass surface.

In various embodiments, a protective layer provides a physical barrier to prevent the electroless plating solution from contacting the surface of the glass, such as a plate or mask, which may be positioned into place by use of a tool or magnetic force that is applied external to the glass wall to guide the barrier, e.g. plate or mask. The barrier may then be affixed to the glass, and may remain in place while the electroless plating process progresses. Optionally, the barrier may then be removed, for example also by use of a tool or magnetic force, leaving a portion of the glass sleeve transparent.

In yet further embodiments, the barrier may provide a chemical barrier, such as by means of a polymer coating. By way of example only, a photocurable monomer, oligomer, or polymer coating may be coated onto the surface of the glass, and then the desired area of the glass may be exposed to light to cure the coating only in the area intended to be protected. According to one exemplary embodiment, positive or negative photolithography masking may be used, wherein a resin is dispensed internally onto a portion of the glass, and then cured by exposure to ultraviolet light. Optionally, after the electroless plating process is complete, the chemical barrier may be removed by any means known.

According to at least certain embodiments, the physical or chemical barrier will not be adversely affected by exposure to the electroless plating solution or other plating conditions such as increased temperature, as it is desired that the barrier remain securely in place during the process.

Once the initial metal layer is deposited onto the glass, either before or after the optional barrier is removed, if present, it may be desirable to further treat the glass surface coated with the layer of metal. By way of example, a post-treatment process such as the addition of one or more subsequent layers of metal, or the addition of a protective layer on top of the layer of metal, are contemplated.

For example, it may, in at least certain embodiments, be desirable to coat one or more additional layers of metal, e.g. the same or different than the first metal layer, on the glass sleeve. This may, for example, improve thickness or uniformity of the metal layer, or may allow a desired color to be achieved. Additionally, desired physical properties may be imparted by choosing a particular combination of metal layers, such as, for example, heat or electric conductivity.

In embodiments where one or more additional layers of metal are deposited subsequent to the first layer, it may be desirable to proceed with a layer being chosen from a metal having a higher electric potential, and then subsequent layers chosen from metals having lower electric potentials then the first. However, embodiments are also contemplated where a metal layer having a lower electric potential is deposited before one or more metal layers having a higher electric potential. In such embodiments, it may be desirable to proceed with subsequent depositions quickly to avoid potential dissolution of the prior metal layer having lower electric potential.

In further embodiments, it may be desirable to coat a layer of a different substance onto the one or more metal layers, for example to protect the metal layer such as from corrosion. By way of non-limiting example, an acrylic layer may be used to protect the metal layer. For example, a solvent-based acrylic paint may be coated onto the metal layer. In further embodiments, the protective layer may be chosen from any layer which prevents the penetration of a gas, such as, for example, O₂ or H₂S.

The protecting layer may be applied onto the metal layer by any method known, such as, for example, by immersing the glass sleeve comprising the metal layer, once dried, in a solution of the protecting layer, by pouring the protecting layer into the glass sleeve comprising the metal layer, by spray deposition, or by any other method which will effectively coat the protecting layer material onto the metal layer.

According to various embodiments, the glass sleeve coated with the metallic layer may have any configuration of coating or decoration. By way of example, as described herein, it may be desirable to deposit a metal coating on all but a portion of a glass sleeve intended for use in an electronic device, wherein the portion onto which the metal layer is not deposited is intended to remain transparent, e.g. for use as a display area that is intended to be viewed through the glass sleeve.

In yet further embodiments, it may be desirable to deposit a metal coating on only a portion of an interior surface of a glass sleeve intended for use in an electronic device, in such a manner as to provide a decoration, such as, for example, a logo or other aesthetic design. This can be achieved by, for example, masking a portion of the glass sleeve while depositing a first metal layer in such a manner as to leave the logo or artistic design transparent, i.e. to display the logo or design as a transparent area contrasted with the coated area. In an alternate embodiment, it may be possible to mask a portion of the glass sleeve while depositing a first metal layer and then masking the sleeve a second time in a reverse image of the first masking, and depositing a second layer of metal, e.g. of a different color or shade, in order to display a logo or design of a different color or shade of metal than the first layer.

Once all steps are completed, the coated hollow glass sleeve may be cleaned and/or optionally further processed in any way known to those of skill in the art, in order to render it suitable for the intended application.

### Coated Glass Sleeves

Also disclosed herein are glass sleeves coated with at least one layer of metal, where the metal has been deposited by an electroless plating method. In various embodiments, the layer of metal is deposited onto at least a portion of an internal surface of a hollow glass sleeve. In yet further embodiments, the layer of metal may comprise some amount, such as a trace or residual amount, of reducing agent. By way of non-limiting example only, the trace or residual amount of reducing agent may be present in an amount ranging up to about 1000 parts per million (“ppm”), such as up to 750 ppm, up to 500 ppm, up to 250 ppm, up to 100 ppm, up to 80 ppm, up to 60 ppm, up to 50 ppm, up to 40 ppm, up to 30 ppm, up to 20 ppm, up to 10 ppm, up to 7 ppm, up to 5 ppm, up to 3 ppm, or up to 1 ppm.

According to further embodiments, an electronic device comprising a coated glass sleeve is disclosed. Such electronic devices include, but are not limited to, personal or hand-held devices such as laptops, cell phones, electronic tablets, watches, media players, and the like. For example, an electronic device may be prepared using a glass enclosure or sleeve that has a layer of metal deposited onto at least a portion of a surface, e.g. an internal surface, by methods described herein. In various embodiments, the layer of metal may comprise some amount, such as a trace or residual amount, of reducing agent.

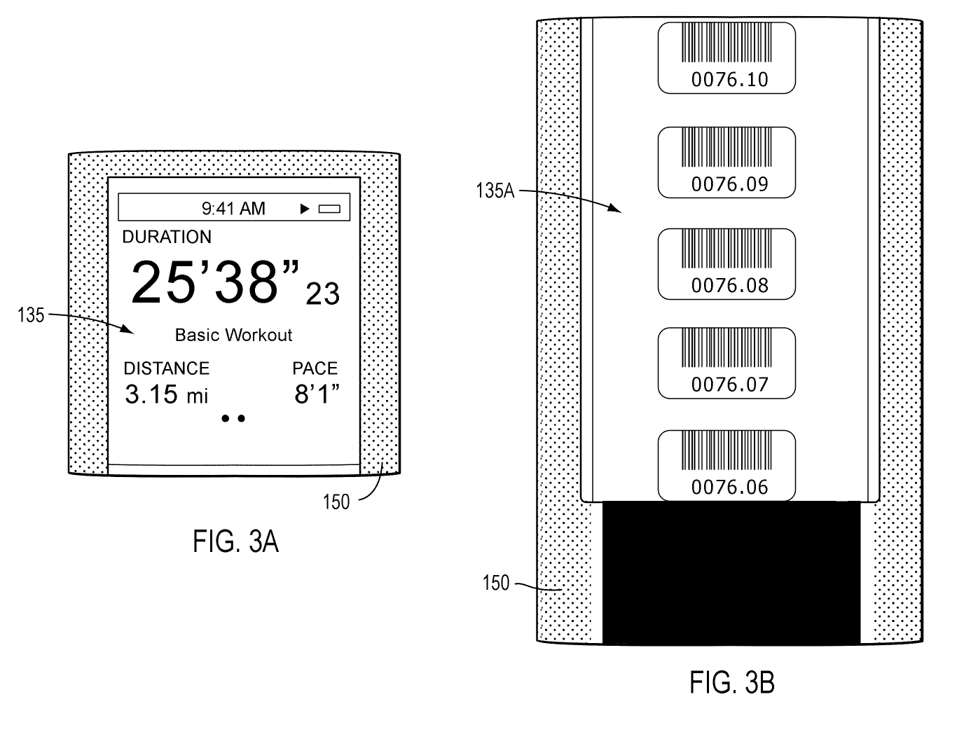

By way of non-limiting example, FIGS. 3A and 3B show two personal electronic devices assembled using glass sleeves that have been coated on an internal surface according to methods described herein. As can be seen on the two devices, the protecting mask can prevent metal layer deposition in an area such as the display area 135 or any other area 135A that is desired to be transparent, while otherwise coating the entire internal surface 150 of the glass sleeve. Alternate embodiments could comprise a similar device with a logo or other decoration plated onto an internal surface of the glass enclosure or sleeve, as described herein.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a portion” includes examples having two or more such portions unless the context clearly indicates otherwise.

Ranges can be expressed herein as from “about” one particular value, and/or to “about” another particular value. When such a range is expressed, examples include the exact value(s) as alternate start and/or end points. Similarly, when values are expressed as approximations, by use of the antecedent “about,” it will be understood that the particular value forms an additional embodiment. It will be further understood that the end points of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Example is intended to be non-restrictive and illustrative only, with the scope of the invention being defined by the claims.

### Example

An exemplary electroless plating process was carried out using a hollow glass sleeve.

The inner surface of the glass sleeve was washed with water ethanol and acetone. One end of the sleeve was sealed. A protecting mask was affixed to the portion of the inner surface of the glass sleeve at the area intended to the display window.

A 4 gram aliquot of glucose was dissolved in 10 mL of distilled water in a 50 mL beaker (reducing solution). Next, 150 mL silver nitrate (0.1 N) were placed in a 250 mL beaker, and 5 mL of concentrated ammonia solution were added while stirring. A brown precipitate of silver oxide formed. Approximately 5 mL of additional ammonia solution were added until the precipitate dissolved (metal-ion solution). The two solutions were mixed together.

The mixed solution was poured into the sleeve and the sleeve was placed in a water bath at 60° C. and regularly shaken. A silver layer was deposited onto the inner surface of the glass sleeve, giving a mirror-like appearance after about 5 minutes. The remaining solution was poured out of the sleeve, and the sleeve was washed with water and ethanol.

After complete drying of the metal coated sample, a solvent-based acrylic paint was deposited by pouring and air cured.

The display area protecting mask was then removed.

What is claimed is:

1. A method for coating an internal surface of a hollow glass sleeve, said method comprising:
contacting at least a portion of the internal surface of the glass sleeve with an electroless plating solution for a time sufficient to deposit a metal layer on at least a portion of the glass sleeve,
the electroless plating solution comprising at least one material for providing metal ions to the glass sleeve and at least one reducing agent.

2. The method according to claim 1, wherein the material for providing metal ions to the glass sleeve comprises at least one metal chosen from palladium, gold, silver, tin, nickel, platinum, aluminum, and copper.

3. The method according to claim 2, wherein the material providing metal ions to the glass sleeve is chosen from aqueous solutions of water-soluble salts of palladium, gold, silver, tin, nickel, platinum, aluminum, and copper.

4. The method according to claim 1, wherein the reducing agent is chosen from glucose, formaldehyde, sodium hypophosphite, glycerol, hydrazine, sodium borohydride, amine boranes, triethanol amine, sodium sulfide, and titanium chloride.

5. The method according to claim 1, comprising a further step of exposing the glass sleeve to an elevated temperature during or after the step of contacting the glass sleeve with the electroless plating solution.

6. The method according to claim 1, further comprising a step of pre-treating at least a portion of the internal surface of the glass sleeve before the glass sleeve is contacted with the electroplating solution.

7. The method according to claim 6, wherein the at least one pre-treatment step is chosen from cleaning, etching, and activating at least a portion of the glass sleeve.

8. The method according to claim 6, wherein the at least one pre-treatment step comprising protecting at least a portion of the glass sleeve from exposure to the electroless plating solution.

9. The method according to claim 8, wherein said protecting step comprises affixing a physical or chemical barrier to at least a portion of the glass sleeve.

10. The method according to claim 1, further comprising at least one post-treatment step after a metal layer is deposited on at least a portion of the glass sleeve.

11. The method of claim 10, wherein the at least one post-treatment step is chosen from cleaning the glass sleeve and adding a protective layer over the metal layer.

12. The method according to claim 11, further comprising a step of removing the physical or chemical barrier.

13. A method for coating at least a portion of an internal surface of a glass sleeve, said method comprising:
affixing a physical or chemical barrier to at least a portion of the internal surface of the glass sleeve,
contacting at least a portion of the internal surface of the glass sleeve with an electroless plating solution for a time sufficient to deposit a metal layer on at least a portion of the glass sleeve,
providing a protective layer to the portion of the internal surface of the glass sleeve comprising the deposited metal layer, and
removing the physical or chemical barrier,
the electroless plating solution comprising at least one material for providing metal ions to the glass sleeve and at least one reducing agent.

14. The method according to claim 13, wherein the material providing metal ions to the glass sleeve is chosen from aqueous solutions of water-soluble salts of palladium, gold, silver, tin, nickel, platinum, aluminum, and copper.

15. A hollow glass sleeve comprising an internal surface, at least a portion of said internal surface coated by an electroless plating method comprising:
affixing a physical or chemical barrier to at least a portion of the internal surface of the glass sleeve,
contacting at least a portion of the internal surface of the glass sleeve with an electroless plating solution for a time sufficient to deposit a metal layer on at least a portion of the glass sleeve,
providing a protective layer to the portion of the internal surface of the glass sleeve comprising the deposited metal layer, and
removing the physical or chemical barrier,
the electroless plating solution comprising at least one material for providing metal ions to the glass sleeve and at least one reducing agent.

16. A hollow glass sleeve comprising an internal surface, said internal surface comprising a layer of metal, wherein said layer of metal comprises trace amounts of at least one reducing agent.

17. An electronic device comprising a glass sleeve, the glass sleeve comprising an internal surface,
wherein said internal surface comprises a layer of metal, and
wherein said layer of metal comprises trace amounts of at least one reducing agent.

18. The electronic device according to claim 17, chosen from laptops, cell phones, electronic tablets, watches, and media players.

19. The electronic device according to claim 17, wherein at least a portion of the internal surface does not comprise a layer of metal.

20. The electronic device according to claim 19, wherein the portion of the internal surface that does not comprise a layer of metal corresponds to a display area of the device.
